(19) United States
(12) Patent Application Publication
(10) Pub. No.: US 2026/0237537 A1
(43) Pub. Date: Aug. 13, 2026

(54) MODE ENGINEERING FOR QUANTUM LOGIC SPECTROSCOPY

(71) Applicant: Quantinuum LLC, Broomfield, CO (US)

(72) Inventor: Robert Tyler SUTHERLAND, San Antonio, TX (US)

(21) Appl. No.: 18/975,108

(22) Filed: Dec. 10, 2024

Related U.S. Application Data
(60) Provisional application No. 63/617,460, filed on Jan. 4, 2024.

(51) Int. Cl. G21K 1/20; G21K 1/30

(52) U.S. Cl. CPC G21K 1/20; G21K 1/30

(57) ABSTRACT

A controller of an atomic system controls voltage sources to cause first and second atomic objects of an object crystal to experience a coupling force. The object crystal is confined at a target location of a confinement apparatus that defines an axis thereat. The coupling force includes a component that is perpendicular to the axis. The controller causes the voltage sources to generate voltage signals that cause the object crystal to experience an axial confinement corresponding to a transition region for selected motional modes of the object crystal. When the atomic objects experience the coupling force and the object crystal experiences the axial confinement corresponding to the transition region, the selected motional modes form mixed motional modes. The controller causes manipulation sources to generate manipulation signals that are incident on the target location and that address the mixed motional modes to cause an entangling interaction between the atomic objects.

### CROSS-REFERENCE TO RELATED APPLICATION(S)

This application claims priority to U.S. Application No. 63/617,460, filed Jan. 4, 2024, the content of which is incorporated herein by reference in its entirety.

### TECHNICAL FIELD

Various embodiments relate quantum logic spectroscopy. For example, various embodiments relate to engineering motional modes of an object crystal for quantum logic spectroscopy.

### BACKGROUND

Quantum logic spectroscopy is a mapping of quantum information between two co-trapped ions of different atomic species. Since the co-trapped ions are different atomic species, they have different masses. Due to the masses of the co-trapped ions being different from one another at least some of the motional modes of an ion crystal including the co-trapped ions to be uncoupled. In other words, some of the motional modes are dominated by one of the ions and other of the motional modes are dominated by the other ion. The uncoupling of the motional modes causes the mapping of the quantum information from one ion to the other to be complicated and slow. Through applied effort, ingenuity, and innovation many deficiencies of such quantum logic spectroscopy systems have been solved by developing solutions that are structured in accordance with the embodiments of the present invention, many examples of which are described in detail herein.

### BRIEF SUMMARY OF EXAMPLE EMBODIMENTS

Example embodiments provide methods, systems, apparatuses, computer program products and/or the like for engineering motional modes of an object crystal to facilitate quantum logic spectroscopy using atomic objects of the object crystal. For example, a motional mode of the object crystal that is dominated by one atomic object is coupled to a motional mode of the object crystal that is dominated by the other atomic object and/or an uncoupled motional mode. An entangling interaction may be performed on the atomic objects while the motional modes are coupled to map quantum information stored by an atomic object of interest to a spectator quantum object.

According to one aspect, a method for performing an entangling operation and/or quantum logic gate is provided. In an example embodiment, the method comprises causing one or more voltage sources to generate coupling signals that cause a first atomic object and a second atomic object of an object crystal to experience a coupling force. The object crystal is confined at a target location of a confinement apparatus, the confinement apparatus defines an axis at the target location, and the coupling force comprises a component in a direction that is radial to the axis. The method further comprises causing the one or more voltage sources to generate voltage signals that cause the object crystal to experience an axial confinement corresponding to a transition region for selected motional modes of the object crystal. When the first atomic object and the second atomic object experience the coupling force and the object crystal experiences the axial confinement corresponding to the transition region, the selected motional modes form mixed motional modes. The method further comprises causing one or more manipulation sources to generate respective manipulation signals such that the respective manipulation signals are incident on the target location. The respective manipulation signals address at least one of the mixed motional modes to cause an entangling interaction between the first atomic object and the second atomic object.

In an example embodiment, the method is performed by a controller of an atomic system including the confinement apparatus, voltage sources, and manipulation sources.

In an example embodiment, the first atomic object has a first mass, the second atomic object has a second mass, and the first mass is not equal to the second mass.

In an example embodiment, the first atomic object and the second atomic object are ions of different atomic species that are confined by a Paul ion trap.

In an example embodiment, the first atomic object that is an atomic object of interest and the second atomic object that is a spectator atomic object.

In an example embodiment, the spectator atomic object is used to sympathetically cool the atomic object of interest.

In an example embodiment, the method further includes causing performance of a reading operation on the spectator atomic object; and based on a result of the reading operation, determining a quantum state of the atomic object of interest.

In an example embodiment, the coupling force is caused by interaction of the first atomic object and the second atomic object with an electric field.

In an example embodiment, causing the one or more voltage sources to generate voltage signals to cause the object crystal to experience the axial confinement corresponding to the transition region comprises causing the voltage sources to generate voltage signals that cause the axial confinement to increase from an initial confinement value to a final confinement value corresponding to the transition region such that the axial confinement increases adiabatically.

In an example embodiment, the axial confinement experienced by the object crystal increases from the initial confinement value to the final confinement value over a time period that is longer than an inverse of a frequency difference between the selected motional modes.

In an example embodiment, an amplitude of the coupling force increases from zero to an interaction amplitude adiabatically over the time period that is longer than the inverse of the frequency difference between the selected motional modes.

In an example embodiment, \the first atomic object and the second atomic object each make a substantial contribution to the mixed motional modes.

In an example embodiment, prior to the one or more manipulation signals being incident on the target location, an amplitude of the coupling force increases from zero to an interaction amplitude adiabatically.

According to another aspect, a system is provided. In an example embodiment, the system includes a confinement apparatus configured to confine an object crystal comprising a first atomic object and a second atomic object at a target location defined at least in part by the confinement apparatus; one or more manipulation sources configured to generate and provide respective manipulation signals; one or more voltage sources configured to provide respective voltage signals to respective electrodes of the confinement apparatus; and a controller configured to control operation of the one or more manipulation sources and the one or more voltage sources. The controller is configured to cause the one or more voltage sources to generate coupling signals that cause the first atomic object and the second atomic object of the object crystal to experience a coupling force. The confinement apparatus defines an axis at the target location and the coupling force comprises a component in a direction that is radial to the axis. The controller is further configured to cause the one or more voltage sources to generate voltage signals that cause the object crystal to experience an axial confinement corresponding to a transition region for selected motional modes of the object crystal. While the first atomic object and the second atomic object experience the coupling force and the object crystal experiences the axial confinement corresponding to the transition region, the selected motional modes form mixed motional modes. The controller is further configured to cause the one or more manipulation sources to generate respective manipulation signals such that the respective manipulation signals are incident on the target location. The respective manipulation signals address at least one of the mixed motional modes to cause an entangling interaction between the first atomic object and the second atomic object.

In an example embodiment, the first atomic object has a first mass, the second atomic object has a second mass, and the first mass is not equal to the second mass.

In an example embodiment, the first atomic object and the second atomic object are ions of different atomic species, and the confinement apparatus is a Paul ion trap.

In an example embodiment, the first atomic object that is an atomic object of interest and the second atomic object that is a spectator atomic object.

In an example embodiment, the controller is further configured to cause performance of a reading operation on the spectator atomic object; and, based on a result of the reading operation, determine a quantum state of the atomic object of interest.

In an example embodiment, the coupling force is caused by interaction of the first atomic object and the second atomic object with an electric field.

In an example embodiment, causing the one or more voltage sources to generate voltage signals to cause the object crystal to experience the axial confinement corresponding to the transition region comprises causing the voltage sources to generate voltage signals that cause the axial confinement to increase from an initial confinement value to a final confinement value corresponding to the transition region such that the axial confinement increases adiabatically.

In an example embodiment, both the first atomic object and the second atomic object make substantial contributions to the mixed motional modes.

According to another aspect, a controller is provided. In various embodiments, the controller includes at least one classical processor and at least one classical memory storing computer-executable instructions. The at least one classical memory and the computer-executable instructions are configured to, when executed by the at least one classical processor, cause the controller to perform causing one or more voltage sources to generate coupling signals that cause a first atomic object and a second atomic object of an object crystal to experience a coupling force. The object crystal is confined at a target location of a confinement apparatus, the confinement apparatus defines an axis at the target location, and the coupling force comprises a component in a direction that is radial to the axis. The at least one classical memory and the computer-executable instructions are further configured to, when executed by the at least one classical processor, cause the controller to perform causing the one or more voltage sources to generate voltage signals that cause the object crystal to experience an axial confinement corresponding to a transition region for selected motional modes of the object crystal. When the first atomic object and the second atomic object experience the coupling force and the object crystal experiences the axial confinement corresponding to the transition region, the selected motional modes form mixed motional modes. The at least one classical memory and the computer-executable instructions are further configured to, when executed by the at least one classical processor, cause the controller to perform causing one or more manipulation sources to generate respective manipulation signals such that the respective manipulation signals are incident on the target location. The respective manipulation signals address at least one of the mixed motional modes to cause an entangling interaction between the first atomic object and the second atomic object.

According to still another aspect, a computer program product is provided. In an example embodiment, the computer program product includes a non-transitory computer-readable medium storing computer-executable instructions. The computer-executable instructions are configured to, when executed by a controller, cause the controller to perform causing one or more voltage sources to generate coupling signals that cause a first atomic object and a second atomic object of an object crystal to experience a coupling force. The object crystal is confined at a target location of a confinement apparatus, the confinement apparatus defines an axis at the target location, and the coupling force comprises a component in a direction that is radial to the axis. The computer-executable instructions are further configured to, when executed by the controller, cause the controller to perform causing the one or more voltage sources to generate voltage signals that cause the object crystal to experience an axial confinement corresponding to a transition region for selected motional modes of the object crystal. When the first atomic object and the second atomic object experience the coupling force and the object crystal experiences the axial confinement corresponding to the transition region, the selected motional modes form mixed motional modes. The computer-executable instructions are further configured to, when executed by the controller, cause the controller to perform causing one or more manipulation sources to generate respective manipulation signals such that the respective manipulation signals are incident on the target location. The respective manipulation signals address at least one of the mixed motional modes to cause an entangling interaction between the first atomic object and the second atomic object.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example atomic system, in accordance with an example embodiment.

FIG. 2 provides a top view of a portion of an example atomic object confinement apparatus that may be used in example embodiment.

FIG. 3A provides schematic diagram of an object crystal confined by an example atomic object confinement apparatus, in accordance with an example embodiment.

FIG. 3B provides a schematic diagram of an object crystal confined by an example atomic object confinement apparatus and experiencing a coupling force, in accordance with an example embodiment.

FIG. 4 provides a plot illustrating the evolution of an object crystal length and a coupling force amplitude during performance of a quantum information mapping, in accordance with an example embodiment.

FIG. 5 provides a plot illustrating the effect of changing the object crystal length on the frequency of two example motional modes of the object crystal while the object crystal is experiencing the coupling force, in accordance with an example embodiment.

FIG. 6 provides a schematic diagram of an example controller of a quantum computer comprising an atomic object confinement apparatus configured for confining atomic objects therein, in accordance with an example embodiment.

FIG. 7 provides a flowchart illustrating various processes and/or procedures performed by a controller to cause an atomic system to perform a quantum logic spectroscopy, in accordance with an example embodiment.

FIG. 8 provides a schematic diagram of an example computing entity of an atomic system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, atomic objects are confined by an atomic object confinement apparatus (also referred to as a confinement apparatus herein). In various embodiments, the atomic objects are ions, ionic molecules, or multipolar molecules, and the atomic object confinement apparatus is an ion trap, such as a surface ion trap, Paul ion trap, and/or the like. In various embodiments, the atomic objects are neutral atoms or molecules, and the atomic object confinement apparatus is an optical trap, magnetic trap, and/or the like.

In various embodiments, the atomic objects confined by the confinement apparatus include at least two atomic species where atomic objects of different atomic species have different masses, different atomic numbers, and/or different molecular compositions. Similarly, atomic objects of the same atomic species have the same masses, atomic numbers, and/or molecular compositions. The atomic objects confined by the confinement apparatus may be organized and/or grouped into object crystals including at least a first atomic object of a first atomic species (e.g., a first mass, atomic number, and/or molecular composition) and a second atomic object of a second atomic species (e.g., a second mass, atomic number, and/or molecular composition), where there first mass, atomic number, and/or molecular composition is different from the second atomic object of a second mass, atomic number, and/or molecular composition.

For example, the first atomic object may be an atomic object of interest. For example, the first atomic object may be used as an atomic clock, qubit of a quantum computer, and/or the like. For instance, the first atomic object may be used to store quantum information, undergo quantum logic operations, and/or the like. For example, the quantum state of the first atomic object may be manipulated to cause controlled evolution thereof (e.g., for us in atomic system experiments, quantum computing, and/or the like). In various embodiments, the first atomic object has a non-zero and/or non-integer nuclear spin. For example, the first atomic object may exhibit hyperfine splitting.

In various embodiments, the second atomic object is a spectator atomic object. For example, the second atomic object may be used to sympathetically laser cool the first atomic object. In various embodiments, the second atomic object has a zero nuclear spin. For example, energy structure and/or quantum state structure of the second atomic object may be less complicated than that of the first atomic object.

The motional modes of the object crystal include axial motional modes that correspond to motion along a longitudinal axis defined by the confinement apparatus and radial motional modes that correspond to motion in directions that are perpendicular to the longitudinal axis defined by the confinement apparatus. The axial motional modes of the object crystal include a stretch mode, where the first and second atomic objects move in opposite directions along the longitudinal axis defined by the confinement apparatus, and a center of mass mode, where the first and second atomic objects move in the same direction along the longitudinal axis. However, performing an entangling gate on the first atomic object and the second atomic object that addresses axial motional modes, are technically very difficult to perform.

The radial motional modes of the object crystal are decoupled due to the mass difference between the first atomic object and the second atomic object. For example, 99% of the energy of the object crystal that is in a first radial mode is kinetic energy of the first atomic object and 98% of the energy of the object crystal in a second radial mode is kinetic energy of the second atomic object. In other words, the first radial mode is dominated by the first atomic object and the second radial mode is dominated by the second atomic object. Thus, if an entangling interaction and/or quantum logic gate is to be performed between the first atomic object and the second atomic object using the first radial mode or the second radial mode, the entangling interaction and/or quantum logic gate will take a long time to perform. The longer an entangling interaction and/or quantum logic gate takes to perform, the larger the effect of noise on the entangling interaction and/or quantum logic gate. In other words, when an entangling interaction and/or quantum logic gate takes a long time to perform, the fidelity of the entangling interaction and/or quantum logic gate may be negatively affected. Therefore, technical problems exist regarding performance of quantum logic spectroscopy.

Various embodiments provide technical solutions to these technical challenges. In various embodiments, a motional mode of the object crystal that is dominated by one atomic object is coupled to a motional mode of the object crystal that contains a significant contribution from the other atomic object. An entangling interaction and/or quantum logic gate may be performed on the atomic objects while the motional modes are coupled to map quantum information stored by an atomic object of interest to a spectator quantum object. This enables the entangling interaction and/or quantum logic gate to be performed more quickly (e.g., on a similar time scale as performing an entangling interaction and/or quantum logic gate on two atomic objects of the same atomic species). The shortened time frame of the entangling interaction and/or quantum logic gate (compared to when the motional modes are not coupled) allows the entangling interaction and/or quantum logic gate to be performed with high fidelity. Moreover, the technical complexity of performing the entangling interaction and/or the quantum logic gate on the two atomic objects of different atomic species is not substantially increased from performing an entangling interaction and/or the quantum logic gate on two atomic objects of the same atomic species. Therefore, various embodiments, provide technical improvements to the fields of atomic systems and quantum logic spectroscopy.

### Example Atomic System

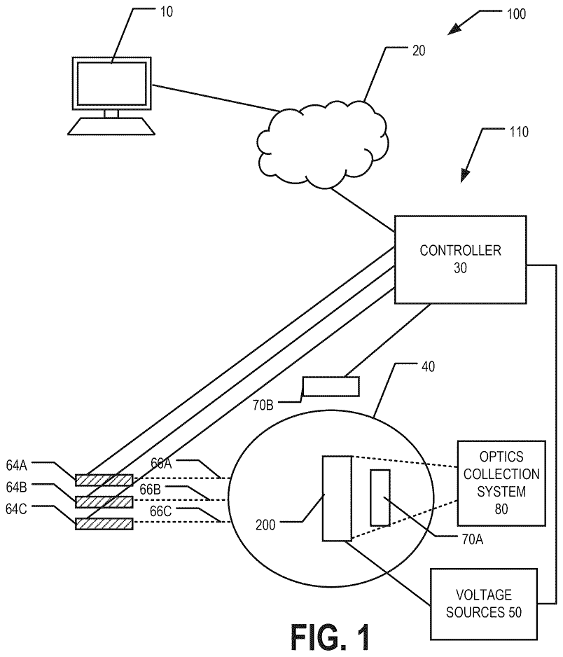

In various embodiments, the atomic objects confined by an atomic object confinement apparatus are used to perform experiments, controlled quantum state evolution, quantum computations, and/or the like. For example, the confinement apparatus may be part of an atomic system such as an atomic clock, quantum charge-coupled device (QCCD)-based quantum computer, and/or the like. FIG. 1 provides a schematic diagram of an example system 100 comprising a confinement apparatus 200 (e.g., an ion trap), in accordance with an example embodiment. In various embodiments, the system 100 comprises a classical and/or semiconductor-based computing entity 10 and an atomic system 110. In various embodiments, the atomic system 110 comprises a controller 30, a cryostat and/or vacuum chamber 40 enclosing a confinement apparatus 200, one or more manipulation sources 64 (e.g., 64A, 64B, 64C), one or more voltage sources 50, one or more magnetic field generators 70 (e.g., 70A, 70B), an optics collection system 80, and/or the like. In various embodiments, the controller 30 is configured to control the operation of (e.g., control one or more drivers configured to cause operation of) the manipulation sources 64, voltage sources 50, magnetic field generators 70, a vacuum system and/or cryogenic cooling system (not shown), and/or the like. In various embodiments, the controller 30 is configured to receive signals (e.g., electrical signals) generated and provided by one or more photodetectors of the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more atomic objects confined by the confinement apparatus 200. For example, a first manipulation source 64A is configured to generate and/or provide a first manipulation signal and a second manipulation source 64B is configured to generate and/or provide a second manipulation signal, where the first and second manipulation signals are configured to collectively laser cool atomic objects and/or object crystals confined by the atomic object confinement apparatus 200. In another example, one or more manipulation sources 64 are configured to generate and/or provide respective manipulation signals that are collectively configured to perform entangling interactions and/or quantum logic gates on atomic objects and/or object crystals confined by the confinement apparatus 200.

In various embodiments, the atomic object confinement apparatus 200 is an ion trap, such as a surface ion trap, Paul ion trap, and/or the like. In various embodiments, the atomic objects are ions, atoms, molecules, and/or the like. In an example embodiment, an object crystal comprises two or more atomic objects of different atomic species (e.g., having different masses, atomic numbers, and/or molecular compositions). In an example embodiment, an object crystal includes a first atomic objects (e.g., atomic objects having a first atomic number) a second atomic objects (e.g., atomic objects having a second atomic number). The first atomic object is an atomic object of interest in the atomic system 100. For example, the first atomic object may be used as an atomic clock, a qubit of a quantum computer, and/or the like. The second atomic object is a spectator atomic object. For example, the spectator atomic object may be used to sympathetically laser cool the first atomic object.

In an example embodiment, the one or more manipulation sources 64 each provide a manipulation signal (e.g., laser beam and/or the like) to one or more regions and/or target locations of the atomic object confinement apparatus 200 via corresponding beam paths 66 (e.g., 66A, 66B, 66C). In various embodiments, at least one beam path 66 comprises a modulator configured to modulate the manipulation signal being provided to the confinement apparatus 200 via the beam path 66. In various embodiments, the manipulation sources 64, active components of the beam paths (e.g., modulators, etc.), and/or other components of the atomic system 110 are controlled by the controller 30.

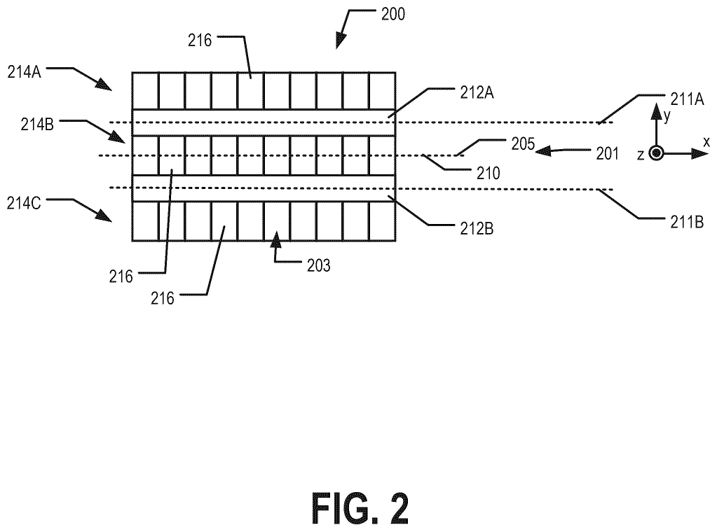

In various embodiments, the atomic system 110 comprises one or more voltage sources 50. For example, the voltage sources may be arbitrary wave generators (AWG), digital analog converters (DACs), and/or other voltage signal generators. For example, the voltage sources 50 may comprise a plurality of control voltage drivers and/or voltage sources and/or at least one RF driver and/or voltage source. The voltage sources 50 may be electrically coupled to the corresponding potential generating elements (e.g., control electrodes 216 and/or RF electrodes 212, as shown in FIG. 2) of the confinement apparatus 200, in an example embodiment.

In various embodiments, the atomic system 110 comprises one or more magnetic field generators 70 (e.g., 70A, 70B). For example, the magnetic field generator may be an internal magnetic field generator 70A disposed within the cryogenic and/or vacuum chamber 40 and/or an external magnetic field generator 70B disposed outside of the cryogenic and/or vacuum chamber 40. In various embodiments, the magnetic field generators 70 comprise permanent magnets, Helmholtz coils, electrical magnets, and/or the like. In various embodiments, the magnetic field generators 70 are configured to generate a magnetic field at one or more regions and/or target locations of the atomic object confinement apparatus 200 that has a particular magnitude and a particular magnetic field direction in the one or more regions and/or target locations of the atomic object confinement apparatus 200.

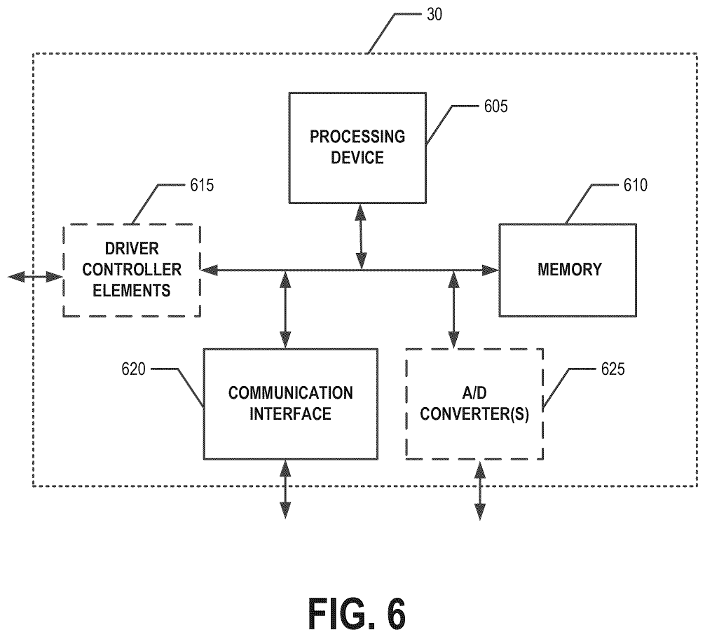

In various embodiments, the atomic system 110 comprises an optics collection system 80 configured to collect and/or detect photons (e.g., stimulated emission) generated by atomic objects (e.g., during reading procedures). The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the atomic objects of the atomic system 110. In various embodiments, the detectors may be in electronic communication with the controller 30 via one or more A/D converters 625 (see FIG. 6) and/or the like.

In various embodiments, a computing entity 10 is configured to allow a user to provide input to the atomic system 110 (e.g., via a user interface of the computing entity 10) and receive, view, and/or the like output from the atomic system 110. The computing entity 10 may be in communication with the controller 30 of the atomic system 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control operation of the voltage sources 50, magnetic field generators 70, cryogenic system and/or vacuum system controlling the temperature and pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more atomic objects confined by the confinement apparatus, and/or read and/or detect a quantum state of one or more atomic objects confined by the confinement apparatus. For example, the controller 30 may cause a controlled evolution of quantum states of one or more atomic objects within the confinement apparatus to execute a quantum circuit and/or algorithm. For example, the controller 30 may read and/or detect quantum states of one or more atomic objects within the confinement apparatus at one or more points during the execution of a quantum circuit or experiment. For example, the controller 30 may cause a quantum logic spectroscopy operation to be performed on an object crystal including a first atomic object and a second atomic object.

### Exemplary Atomic Object Confinement Apparatus

FIG. 2 provides a top view of at least a portion of an example confinement apparatus 200 that may be used to confine at least two atomic objects. For example, in an example embodiment, the confinement apparatus is an ion trap (e.g., a surface ion trap, Paul ion trap) and the atomic objects are ions. In an example embodiment, the confinement apparatus 200 is at least partially defined by a number of RF electrodes 212 (e.g., 212A, 212B). In various embodiments, the confinement apparatus 200 is at least partially defined by a number of sequences of control electrodes 214 (e.g., 214A, 214B, 214C). Each sequence of control electrodes 214 comprises a plurality of control electrodes 216. In an example embodiment, each control electrode 216 and/or at least a non-empty subset of the control electrodes 216 may be operated independently via the application of control signals thereto. In an example embodiment, the confinement apparatus 200 is a surface Paul trap with symmetric RF electrodes 212. In various embodiments, the RF electrodes 212 and the control electrodes 216 generate potentials and/or fields that are experienced by atomic objects within a confinement region 201 of the confinement apparatus 200. In particular, the RF electrodes 212 may be configured to define the confinement region 201 of the confinement apparatus 200 and the control electrodes 216 may be configured to at least partially control movement and/or motion of atomic objects within the confinement region 201.

In various embodiments, the upper surface of the confinement apparatus 200 has a planarized topology. For example, the upper surface of each RF electrode 212 of the number of RF electrodes 212 and the upper surface of each control electrode 216 of the number of sequences of control electrodes 214 may be substantially coplanar.

In various embodiments, the confinement apparatus 200 comprises and/or is at least partially defined by a number of RF electrodes 212. The RF electrodes 212 are formed with substantially parallel longitudinal axes 211 (e.g., 211A, 211B) and with substantially coplanar upper surfaces. For example, the RF electrodes 212 are substantially parallel such that a distance between the RF electrodes 212 is approximately constant along the length of the RF electrodes 212 (e.g., the length of an RF electrode being along the longitudinal axes 211 of RF electrode 212). For example, the upper surfaces of the RF electrodes 212 may be substantially flush with the upper surface of the confinement apparatus 200.

In an example embodiment, the number of RF electrodes 212 comprises two RF electrodes 212 (e.g., 212A, 212B). In various embodiments, the confinement apparatus 200 may comprise a plurality of number of RF electrodes 212. For example, the confinement apparatus 200 may be a two-dimensional ion trap that comprises multiple numbers (e.g., pairs and/or sets) of RF electrodes 212 with each number (e.g., pair and/or set) of RF electrodes 212 having substantially parallel longitudinal axes 211. In an example embodiment, a first number of RF electrodes 212 have mutually substantially parallel longitudinal axes 211, a second number of RF electrodes 212 have mutually substantially parallel longitudinal axes 211, and the longitudinal axes of the first number of RF electrodes and the longitudinal axes of the second number of RF electrodes are substantially non-parallel (e.g., transverse). FIG. 2 illustrates an example one dimensional confinement apparatus 200 and/or a portion of a two-dimensional confinement apparatus 200 having two RF electrodes 212, though other embodiments may comprise additional RF electrodes in various configurations.

In various embodiments, two adjacent RF electrodes 212 may be separated (e.g., insulated) from one another by a longitudinal gap. In various embodiments, the confinement region 201 is at least partially over the longitudinal gap. For example, the longitudinal gap may define (in one or two dimensions) the confinement region 201. In various embodiments, the confinement region 201 may extend substantially parallel to the longitudinal axes 211 of the adjacent RF electrodes 212. For example, the longitudinal gap may extend substantially parallel to the x-axis as shown in FIG. 2. In an example embodiment, the longitudinal gap may be at least partially filled with an insulating material (e.g., a dielectric material). In various embodiments, the dielectric material may be silicon dioxide (e.g., formed through thermal oxidation) and/or other dielectric and/or insulating material. In various embodiments, the longitudinal gap has a height (e.g., in the y-direction) of approximately 40 μm to 500 μm. In various embodiments, one or more sequences of control electrodes 214 (e.g., a second sequence of control electrodes 214B) may be disposed and/or formed within the longitudinal gap.

In an example embodiment, a transverse gap may exist between neighboring and/or adjacent control electrodes 216 of the one or more sequences of control electrodes 214. In an example embodiment, the transverse gap may be empty space and/or at least partially filled with a dielectric material to prevent electrical communication between neighboring and/or adjacent electrodes. In an example embodiment, the transverse gap between neighboring and/or adjacent electrodes may be in the range of approximately 1-10 μm.

In an example embodiment, a longitudinal gap exists between a sequence of control electrodes 214 and a neighboring and/or adjacent RF electrode 212. In an example embodiment, the longitudinal gap may be at least partially filled with a dielectric and/or insulating material to prevent electrical communication between control electrodes 216 of the sequence of control electrodes 214 and the RF electrode 212. In an example embodiment, the longitudinal gap between neighboring and/or adjacent electrodes may be in the range of approximately 1-10 μm.

In various embodiments, the confinement apparatus 200 may be at least partially defined by a number of sequences of control electrodes 214 (e.g., first sequence of control electrodes 214A, second sequence of control electrodes 214B, third sequence of control electrodes 214C). Each sequence of control electrodes 214 is formed to extend substantially parallel to the substantially parallel longitudinal axes 211 of the RF electrodes 212. For example, the number of sequences of control electrodes 214 may extend substantially parallel to the x-axis as shown in FIG. 2. In various embodiments, the number of sequences of control electrodes 214 comprises two, three, four, and/or another number of sequences of control electrodes 214. In an example embodiment, the confinement apparatus 200 comprises a plurality of number of sequences of control electrodes 214. For example, the illustrated confinement apparatus 200 is a one-dimensional ion trap comprising three sequences of control electrodes 214. For example, the confinement apparatus 200 may be a two-dimensional ion trap that comprises multiple numbers of sequences of control electrodes 214 that each extend substantially parallel to a substantially parallel longitudinal axes of a corresponding number of RF electrodes 212. In an example embodiment, a first number of sequences of control electrodes 214 extend substantially parallel to the substantially parallel longitudinal axes 211 of a first number of RF electrodes 212, a second number of sequences of control electrodes 214 extend substantially parallel to the substantially parallel longitudinal axes 211 of a second number of RF electrodes 212, and the longitudinal axes of the first number of RF electrodes and the longitudinal axes of the second number of RF electrodes are substantially non-parallel (e.g., transverse). In some embodiments, each of the control electrodes 216 of the number of sequences of control electrodes 214 can be formed with substantially coplanar upper surfaces that are substantially coplanar with the upper surfaces of the RF electrodes 212.

In an example embodiment (e.g., as illustrated in FIG. 2), a number (e.g., pair) of RF electrodes 212 may be formed between a first sequence of control electrodes 214A and a third sequence of control electrodes 214C with a second sequence of control electrodes 214B extending along the longitudinal gap between the RF electrodes 212. For example, each sequence of control electrodes 214 may extend in a direction substantially parallel to the longitudinal axes 211 of the RF electrodes 212 (e.g., in the x-direction). In various embodiments, the upper surfaces of the sequences of control electrodes 214 are substantially coplanar with the upper surfaces of the RF electrodes 212.

In various embodiments, RF signals may be applied to the RF electrodes 212 to generate an electric and/or magnetic field that acts to maintain one or more atomic objects (e.g., ion(s)) trapped within the confinement apparatus 200 in directions transverse to the longitudinal direction of the confinement apparatus 200 (e.g., the y- and z-directions). In various embodiments, control signals and/or voltages are applied to the control electrodes 216 to generate a desired electric potential field within the confinement region 201. For example, in various embodiments, time-dependent, time-varying, time evolving, and/or non-static direct current (DC) voltages may be applied to the control electrodes 216 to generate a time-dependent, time-varying, time evolving, and/or non-static electric potential field that causes the atomic objects trapped within the confinement apparatus 200 to traverse corresponding trajectories to within the confinement region 201. For example, the atomic objects may be moved between various zones, regions, and/or target locations of the confinement apparatus 200 such that various functions may be performed thereon. For example, the atomic objects may be initialized, gated via single qubit gates, gated via double/multiple qubit gates, transported and/or stored, read and/or detected, and/or the like.

In various embodiments, transportation and/or performance of other functions on the atomic objects may provide heat or motional energy to the atomic objects. Thus, in various embodiments, it may be desired to cool the atomic objects (e.g., and/or object crystals that include the atomic objects).

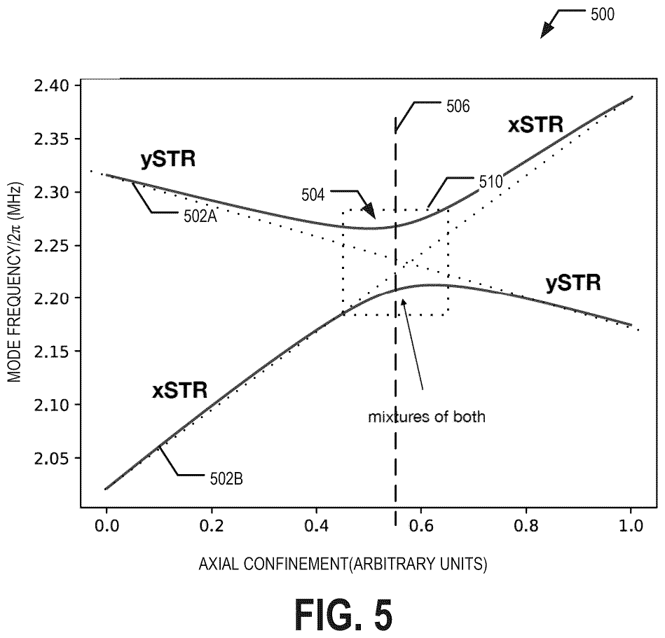

In various embodiments, the control signals and/or voltages applied to the control electrodes 216 are generated by one or more voltage sources 50. For example, a control electrode 216 may be in electric communication with a respective voltage source 50 via one or more of leads, wires, traces, vias, and/or the like. The operation of the one or more voltage sources 50 is controlled by one or more connected devices (e.g., a controller 30 as shown in FIG. 5 and/or the like). For example, depending on the electric monopole and/or dipole (or higher magnitude pole) strength (e.g., electric charge in the case of an electric monopole) of the atomic object, the amplitude of control signals (e.g., voltages) applied to the control electrodes 216 may be increased or decreased in the vicinity of a particular atomic object to cause the particular atomic object to traverse a desired trajectory. For example, a controller 30 may control a voltage driver of the voltage sources 50 to cause the voltage driver to apply control signals and/or voltages to the control electrodes 216 to generate a time-dependent electric potential (e.g., an electric potential that evolves, changes, and/or varies with time) that causes the atomic objects within the confinement apparatus 200 to traverse desired trajectories.

Depending on such factors as the electric monopole and/or dipole (or higher magnitude pole) strength (e.g., electric charge in the case of an electric monopole) of the atomic objects and/or the shape and/or magnitude of the combined electrical and/or magnetic fields, the atomic objects can be stabilized at a particular distance (e.g., approximately 20 μm to approximately 200 μm) above an upper surface of the confinement apparatus 200 (e.g., the coplanar upper surface of the sequences of control electrodes 214 and RF electrodes 212). To further contribute to controlling the transit of atomic objects along desired trajectories, the confinement apparatus 200 may be operated within a cryogenic and/or vacuum chamber capable of cooling the confinement apparatus 200 to a temperature of less than 124 Kelvin (e.g., less than 100 Kelvin, less than 50 Kelvin, less than 10 Kelvin, less than 5 Kelvin, and/or the like), in various embodiments.

In various embodiments, the RF electrodes 212, the sequences of control electrodes 214, and/or the confinement potential generated by the RF electrodes and/or the sequences of control electrodes 214 define a confinement region 201 of the confinement apparatus 200. In an example embodiment, the RF electrodes 212 and/or the confinement potential generated by the RF electrodes define a confinement region 201 of the confinement apparatus 200 and the control electrodes 216 control the movement and/or positioning of the atomic objects within the confinement region 201. In various embodiments, the RF electrodes 212, the sequences of control electrodes 214, and/or the confinement potential generated by the RF electrodes and/or the sequences of control electrodes 214 define a longitudinal axis 205 of the confinement apparatus 200. For example, the RF electrodes 212 and/or the confinement potential generated by the RF electrodes may define a longitudinal axis 205 of the confinement apparatus 200. In various embodiments, the confinement potential generally acts to align the atomic objects within the confinement apparatus 200 along the RF null axis 210 and/or the longitudinal axis 205 of the confinement apparatus 200.

As noted above, various other embodiments may use various other types of confinement apparatuses, such as optical traps, magnetic traps, other types of ion traps, and/or the like, as appropriate for the application and the atomic objects.

### Example Quantum Logic Spectroscopy

Various embodiments provide quantum computers, systems, apparatuses, and/or the like and corresponding methods for performing quantum logic spectroscopy. In various embodiments, an entangling interaction and/or quantum logic gate is performed on a first atomic object of a first atomic species and a second atomic object of a second atomic species to map quantum information stored by the first atomic object to the second atomic object. In an example embodiment, a reading operation is then performed on the second atomic object. The result of the reading operation is used to determine a quantum state of the first atomic object. In various embodiments, the sequence of performing the entangling interaction and/or quantum logic gate on the first and second atomic objects and then performing the reading operation may be performed multiple times. The quantum state of the first atomic object may then be determined based on the distribution of results of performing the reading operation on the second atomic object.

In various embodiments, motional modes of the object crystal are coupled. The entangling interaction and/or quantum logic gate may be configured to address the atomic objects via interaction with motional modes thereof. For example, the entangling interaction and/or quantum logic gate may be a Mølmer-Sørensen (MS) gate or another quantum gate that addresses one or more motional modes of an object crystal. However, due to the decoupling of the radial motional modes of the object crystal, addressing both the first atomic object and the second atomic object via the same entangling interaction and/or quantum logic gate requires the entangling interaction and/or quantum logic gate to be performed for an extended period of time.

In various embodiments, the challenge imposed by the decoupling of the radial motional modes is overcome by coupling a radial mode dominated by one of the atomic objects with at least one of an axial mode of the object crystal or with a radial mode dominated by the other of the atomic objects. The coupling of the motional modes is performed by increasing the axial confinement experienced by the object crystal and applying a coupling force.

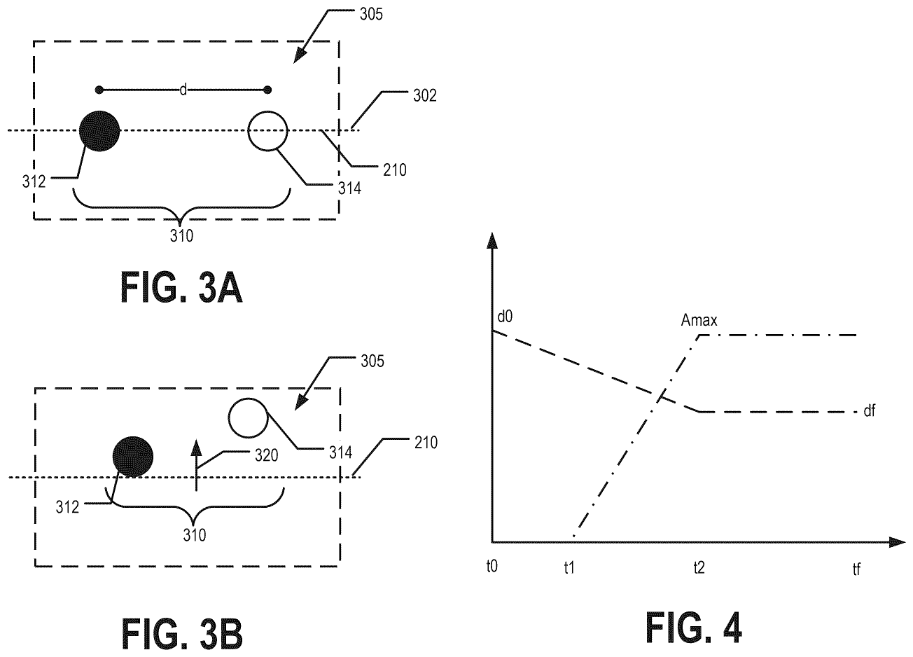

FIG. 3A illustrates an object crystal 310 comprising a first atomic object 312 and a second atomic object 314 located at a target location 305. The target location 305 is defined, at least in part, by the confinement apparatus 200. The first atomic object 312 and second atomic object 314 are aligned along object axis 302. In various embodiments, the object axis 302 is parallel and/or co-linear with the RF null axis 210 and/or the longitudinal axis 205 of the confinement apparatus 200 at the target location 305. The physical extent or length of the object crystal 310 is the object crystal length d. As should be understood, the object crystal, in various embodiments, may include more than two atomic objects and may include atomic objects of more than two atomic species (e.g., atomic objects of different atomic masses, atomic numbers, and/or molecular compositions).

The illustrated object crystal 310 comprising a first atomic object 312 and a second atomic object 314 has six different motional modes. For example, the motional modes of the object crystal 310 include two axial motional modes that in the direction of the object axis 302, two radial motional modes that are perpendicular to the object axis 302 and that are in the plane of the page, and two radial motional modes that are perpendicular to the object axis 302 and that are perpendicular to the plane of the page, in an example embodiment.

The axial motional modes of the object crystal 310 include substantial contributions from both the first atomic object 312 and the second atomic object 314. For example, the first atomic object 312 contributes in a range of 5-95% of the energy in each axial motional mode and the second atomic object 314 contributes in a range of 5-95% of the energy in each axial motional mode.

The radial motional modes of the object crystal 310 are decoupled such that one of the first atomic object 312 or the second atomic object 314 contributes more than 95% of the energy in a particular radial motional mode and the other of the first atomic object 312 or the second atomic object 314 contributes less than 5% of the energy in the particular radial motional mode.

To enable an entangling interaction or quantum logic gate to address both the first atomic object 312 and the second atomic object 314 efficiently via the radial motional modes of the object crystal 310, one or more mixed motional modes of the object crystal are formed by coupling selected motional modes of the object crystal. For example, a first radial motional mode of the object crystal 310 is coupled to one or more other motional modes of the object crystal 310 to form one or more mixed motional modes. For example, a first radial motional mode of the object crystal 310 that is dominated by the first atomic object (e.g., the first atomic object contributes more than 95% of the energy in the first radial motional mode) is coupled to at least one of an axial motional mode of the object crystal 310 (e.g., which includes substantial contributions from both the first atomic object 312 and the second atomic object 314) or a second radial motional mode of the object crystal 310 that is dominated by the second atomic object (e.g., the second atomic object contributes more than 95% of the energy in the second radial motional mode). In this example, the first radial motional mode and the axial motional mode and/or the second radial motional mode are the selected motional modes that are coupled to form a mixed motional mode.

For example, a mixed motional mode is formed that includes contributions from both the first radial motional mode and an axial motional mode and/or a second radial motional mode. The mixed motional mode is then addressed by the entangling interaction and/or quantum logic gate to efficiently map the quantum information stored by the first atomic object 312 to the second atomic object 314 with high fidelity.

In various embodiments, the selected motional modes of the object crystal 310 are coupled to one another to form the mixed motional modes by applying a coupling force to the object crystal 310 and increasing the axial confinement of the object crystal 310. For example, the first radial motional mode of the object crystal 310 may be dressed by the other selected motional modes of the object crystal 310 via application of the coupling force to the object crystal 310 and the controlling the axial confinement of the object crystal 310. The mixed motional modes include substantial contributions from both the first atomic object 312 and the second atomic object 314. For example, in various embodiments, the first atomic object contributes 5-95% of the energy of a mixed motional mode and the second atomic object contributes 5-95% of the mixed motional mode.

FIGS. 4 and 5 illustrate various components of how a quantum logic spectroscopy operation is performed by coupling selected motional modes of the object crystal to form mixed motional modes. FIG. 5 provides a plot 500 illustrating how the mode frequencies of two different motional modes 502 (e.g., 502A, 502B) of an object crystal 310 evolve as the axial confinement experienced by the object crystal 310 increases. As should be understood, the object crystal 310 is confined within a confinement well (e.g., a potential well) generated by the confinement apparatus 200. For example, the application of appropriate voltage signals to the RF electrodes 212 and the control electrodes 216 of the confinement apparatus 200 causes the electric potential well that acts as a confinement well and confines the object crystal. The physical width of the confinement well (in the direction of the longitudinal axis 205) corresponds to and/or controls the object crystal length d. The physical width of the confinement well (in the direction of the longitudinal axis 205) corresponds to the strength of the axial confinement experienced by the object crystal 310. For example, as the axial confinement experienced by the object crystal 310 is increased, the object crystal length d decreases. For example, voltage signals may be provided to the control electrodes 216 to cause the curvature of the (electric) potential well within which the object crystal is confined to increase in the direction of the longitudinal axis 205. This causes the object crystal length d to decrease and the frequency (e.g., a harmonic oscillator frequency) corresponding to the potential well in the direction of the longitudinal axis 205 to increase. Similarly, the voltage signals provided to the control electrodes 216 may be controlled to cause the curvature of the (electric) potential well within which the object crystal is confined to decrease in the direction of the longitudinal axis 205 to cause the object crystal length d to increase, if so desired.

The mode frequency of a first motional mode 502A (a radial stretch mode in the illustrated example) decreases as the axial confinement is increased from an initial confinement and the mode frequency of a second motional mode 502B (an axial stretch mode in the illustrated example) increases as the axial confinement is increased from the initial confinement. The frequency difference between the mode frequencies of the first motional mode 502A and the second motional mode 502B decreases until a point of minimum frequency difference 504 is reached. The point of minimum frequency difference 504 occurs when the axial confinement experienced by the object crystal 310 is at a minimum difference confinement 506.

As the axial confinement experienced by the object crystal 310 continues to increase past the minimum difference confinement 506, the mode frequency of the first motional mode 502A increases and the mode frequency of the second motional mode 502B decreases. Moreover, after the axial confinement increases past the minimum difference confinement 506, the first motional mode 502A is an axial stretch mode and the second motional mode 502B is a radial stretch mode.

If the coupling force was not present, the mode frequency of the first motional mode 502A would continue to decrease through the minimum difference confinement 506 and the mode frequency of the second motional mode 502B would continue to increase through the minimum difference confinement 506, as shown by the dotted lines. However, the coupling force causes the first motional mode 502A to couple to the second motional mode 502B to form a mixed motional mode while the axial confinement is in a transition region 510 about the minimum difference confinement 506. While the axial confinement is within the transition region 510, the first motional mode 502A and the second motional mode 502B are mixed motional modes that are mixtures of the radial stretch mode and the axial stretch mode. When the axial confinement continues to increase out of the transition region, the first motional mode 502A has transitioned from the radial stretch mode to the axial stretch mode. Similarly, as the axial confinement increases through the transition region 510, the second motional mode 502B transitions from the axial stretch mode to the radial stretch mode. In various embodiments, the width of the transition region 510 in axial confinement is dependent on the first motional mode 502A and the second motional mode 502B.

While the axial confinement is within the transition region 510, the mixed motional modes include substantial contributions from both the first atomic object 312 and the second atomic object 314. An entangling interaction and/or quantum logic gate may be performed on the object crystal 310 while the axial confinement is within the transition region 510 (and the coupling force is being experienced by the first atomic object 312 and the second atomic object 314) to efficiently map the quantum information stored by the first atomic object 312 onto the second atomic object 314 with high fidelity.

FIG. 3B illustrates an example result of the object crystal 310 experiencing the coupling force 320. In an example embodiment, that first atomic object 312 and the second atomic object 314 experience the coupling force 320 as a push in a direction that includes a component that is perpendicular to the RF null axis 210. In an example embodiment, the push of the coupling force has a different amplitude at the location of the first atomic object 312 compared to at the location of the second atomic object 314. In an example embodiment, the push of the coupling force has the same amplitude at the location of the first atomic object 312 and the location of the second atomic object 314. For example, one or more coupling signals may be generated (e.g., by voltage sources 50) and applied to respective electrodes (e.g., control electrodes 216) to cause an electric field to be generated that causes the atomic objects 312, 314 to experience a force or push in a direction that includes a component that is perpendicular to the longitudinal axis 205 and/or the RF null axis 210.

In an example embodiment, the coupling force is a torque caused by a shim field in a plane that is parallel to a plane defined by a surface of the atomic object confinement apparatus 200 (e.g., the xy plane as illustrated in FIG. 2). For example, one or more coupling signals may be generated and applied to respective electrodes (e.g., control electrodes 216) to cause a (electric) shim field to be generated that causes the atomic objects 312, 314 to experience the shim field.

In an example embodiment, the coupling force is a higher order (third, fourth, etc.) derivative term in a potential generated by the confinement apparatus at the location of the object crystal. As used herein, a higher order derivative term refers to a derivative term that is third order or higher. For example, voltage sources 50 generate and provide voltage signals that are applied to control electrodes 216 of the confinement apparatus 200. The application of the voltage signals to the control electrodes 216 causes a potential (e.g., an electric potential) to be generated. The potential generated at the location of the object crystal may be configured (e.g., via the applied voltage signals) to include higher order derivatives (e.g., third, fourth, etc. order derivatives) that, when the object crystal experiences the potential, the object crystal experiences the coupling force.

In various embodiments, the first atomic object 312 and the second atomic object 314 have different masses (e.g., one is heavier and/or more massive than the other). Moreover, the pseudopotential used to confine the atomic objects scales with the inverse of mass of the atomic object confined. As a result, the more massive atomic object moves a further distance from the RF null axis 210 than the less massive atomic object, as shown in FIG. 3B. This causes a coulomb force between the first atomic object 312 and the second atomic object 314 to have components in both the axial direction (e.g., parallel to the RF null axis 210 and/or longitudinal axis 205) and the radial direction (e.g., perpendicular to the RF null axis 210). As the coulomb force between the first atomic object 312 and the second atomic object 314 has components in both the axial direction (e.g., parallel to the RF null axis 210) and components in a radial direction (e.g., perpendicular to the RF null axis 210) as a result of the object crystal 310 experiencing the coupling force 320, the coulomb force between the first atomic object 312 and the second atomic object 314 couples the axial and radial motional modes of the atomic objects 312, 314 and/or of the object crystal 310 such that mixed motional modes that combinations of radial motional modes and axial motional modes are formed.

In various embodiments, the formation of the mixed motional modes by coupling the selected motional modes of the object crystal is performed adiabatically. For example, at least one of the atomic objects of the object crystal may be used to store quantum information. For example, the evolution of the quantum state of the first atomic object may be controlled (e.g., as part of performing a quantum circuit and/or the like). To maintain and/or not destroy the quantum information stored by at least one atomic object of the object crystal, the formation of the mixed motional modes of the object crystal is performed coherently. The adiabatic mixing of the selected motional modes to form the mixed motional modes of the object crystal ensures that the mixed motional modes of the object crystal are formed coherently (e.g., without affecting the quantum state of the first atomic object 312 and/or the second atomic object 314).

As should be understood by one of skill in the art, an adiabatic coupling of the selected motional modes of the object crystal to form the mixed motional modes is a coupling that occurs slowly enough to prevent the object crystal undergoing the motional mode coupling from experiencing transitions to other eigenstates. For example, the motional mode coupling occurs slowly relative to the frequency difference between the mode frequency(ies) of the selected motional modes being coupled.

To cause the coupling of the selected motional modes of the object crystal to be performed adiabatically, the coupling force is turned on slowly. For example, in an example embodiment, the amplitude of the coupling force is zero at the beginning of the performance of the quantum logic spectroscopy operation. The amplitude of the coupling force is slowly (with respect to the frequency difference between the motional mode frequency (ies) of the selected motional modes being coupled) increased to a maximum amplitude. The amplitude of the coupling force is then maintained at the maximum amplitude until completion of the quantum logic spectroscopy operation. In some embodiments, after completion of the quantum logic spectroscopy operation, the coupling force is turned off slowly (with respect to the frequency difference between motional mode frequency(ies) of the selected motional modes) such that the amplitude of the coupling force is decreased from the maximum amplitude back to zero. In some embodiments, after completion of the quantum logic spectroscopy operation, the coupling force is turned off quickly, reduced to an amplitude that is greater than zero, and/or maintained at the maximum amplitude. In an example embodiment, the coupling force is present at the maximum amplitude prior to the performance of the quantum logic spectroscopy operation and is maintained at the maximum amplitude through the performance of the quantum logic spectroscopy operation. Particularly, any change in the coupling force during the quantum logic spectroscopy operation is adiabatic.

FIG. 4 illustrates, for an example embodiment, evolution of the object crystal length d (the dashed line) and the evolution of the amplitude of the coupling force (the dotted line) from an initial time t₀ when performance of a quantum logic spectroscopy operation is initiated to a final time t_{f} when performance of the quantum logic spectroscopy operation is completed. Starting at the initial time t₀, the object crystal length d is equal to an initial length d₀. At the final time t_{f}, the object length d is equal to a final length d_{f}. In an example embodiment, the initial length d₀ is 4 microns and the final length d_{f} is 3 microns. In various embodiments, various other initial lengths do and/or final lengths d_{f} may be used as appropriate for the application. In an example embodiment, the object crystal length d is increased instead of decreased (e.g., the final length d_{f} is larger than the initial length d₀). For example, in an example embodiment, the axial confinement is decreased such that the object crystal length d increases between the initial time t₀ to the second time t₂.

In various embodiments, the object crystal length d decreases/increases monotonically between the initial time t₀ and a second time t₂. In the illustrated embodiment, the object crystal length d decreases/increases linearly between the initial time t₀ and the second time t₂. In various embodiments, the object crystal length d decreases/increases between the initial time t₀ and the second time t₂ monotonically in various forms (e.g., quadratically, cubically, exponentially, etc.).

At a first time t₁, which is after and/or at the same time as the initial time t₀ (when the evolution of the object crystal length d was initiated, started, and/or begun), the amplitude of the coupling force is increased from zero amplitude. In various embodiments, t₁≥t₀. At a second time t₂, which is after the first time t₁ (t₂>t₁), the coupling force reaches a maximum amplitude Aₘₐₓ.

After reaching the second time t₂, the amplitude of the coupling force and the axial confinement (and therefore the object crystal length d) are held constant through the final time t_{f} (t_{f}>t₂). The manipulation signals configured to cause the entangling interaction and/or quantum logic gate to be performed on the first atomic object 312 and the second atomic object 314 are incident on the target location 305 for at least a portion of the time between the second time t₂ and the final time tr. For example, for at least a portion of the time between the second time t₂ and the final time t_{f} the manipulation signals configured to cause the entangling interaction and/or quantum logic gate to be performed on the first atomic object 312 and the second atomic object 314 are incident on the first atomic object 312 and the second atomic object 314. For example, the entangling interaction and/or quantum logic gate is performed on the first atomic object 312 and the second atomic object 314 between the second time t₂ and the final time t_{f}.

In various embodiments, a time period over which the axial confinement is increased (e.g., from an initial confinement value corresponding to an initial object crystal length d₀ to a final confinement value corresponding to a final object crystal length d_{f}) is longer than an inverse of a frequency difference between selected motional modes. For example, if the selected motional modes include a first motional mode characterized by a first frequency f₁ and a second motional mode characterized by a second frequency f₂, the time period over which the axial confinement is increased from the initial confinement value to the final confinement value (e.g., t₂−t₀) is longer than the inverse of the frequency difference between the first and second frequencies. In other words,

$${t}_{2} - {t}_{0} > \frac{1}{\vert {f}_{2} - {f}_{1} \vert} .$$

In an example embodiment, the time between the initial time t₀ and the second time t₂ (e.g., t₂−t₀) is approximately 5 μs.

In an example embodiment, the coupling force is generated by applying a (non-oscillating) coupling signal (e.g., a voltage signal generated by a voltage source 50) to one or more control electrodes 216. Causing the amplitude of the coupling force to increase is accomplished by increasing the voltage amplitude of the coupling signal (e.g., from zero to a maximum voltage). In various embodiments, the (absolute) maximum voltage (e.g., resulting in the maximum amplitude of the coupling force) is in a range of one to twenty volts.

### Example Controller

In various embodiments, a confinement apparatus 200 is incorporated into an atomic system 110. In various embodiments, an atomic system 110 further comprises a controller 30 configured to control various elements of the atomic system 110. For example, the controller 30 may be configured to control operation of the voltage sources 50, a cryogenic system and/or vacuum system controlling the temperature and pressure within the cryogenic and/or vacuum chamber 40, manipulation sources 64 (e.g., 64A, 64B, 64C), magnetic field generators 70, active components of beam paths 66, and/or other systems controlling the environmental conditions (e.g., temperature, humidity, pressure, and/or the like) within the cryogenic and/or vacuum chamber 40, configured to manipulate and/or cause a controlled evolution of quantum states of one or more atomic objects confined by the confinement apparatus, and/or read/detect a quantum state of one or more atomic objects within the confinement apparatus.

As shown in FIG. 6, in various embodiments, the controller 30 may comprise various controller elements including processing device 605, memory 610, driver controller elements 615, a communication interface 620, analog-digital converter elements 625, and/or the like. For example, the processing device 605 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products. In an example embodiment, the processing device 605 of the controller 30 comprises a clock and/or is in communication with a clock.

For example, the memory 610 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 610 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 610 (e.g., by a processing device 605) causes the controller 30 to perform one or more steps, operations, processes, procedures and/or the like described herein for controlling one or more components of the atomic system 110 (e.g., voltage sources 50, manipulation sources 64, magnetic field generators 70, and/or the like) to cause a controlled evolution of quantum states of one or more atomic objects, read/detect the quantum state of one or more atomic objects, and/or the like.

In various embodiments, the driver controller elements 615 may include one or more drivers and/or controller elements each configured to control one or more drivers. In various embodiments, the driver controller elements 615 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 605). In various embodiments, the driver controller elements 615 may enable the controller 30 to operate a manipulation source 64. In various embodiments, the drivers may be laser drivers; vacuum component drivers; drivers for controlling the flow of current and/or voltage applied to longitudinal, RF, and/or other electrodes used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the control electrodes 216 and/or RF electrodes 212 (e.g., including coupling signals).

In various embodiments, the controller 30 comprises means for communicating and/or receiving signals from one or more detectors such as optical receiver components (e.g., cameras, MEMs cameras, CCD cameras, photodiodes, photomultiplier tubes, and/or the like). For example, the controller 30 may comprise one or more analog-digital converter elements 625 configured to receive signals from one or more detectors, optical receiver components, calibration sensors, photodetectors of an optics collection system 80, and/or the like.

In various embodiments, the controller 30 may comprise a communication interface 620 for interfacing and/or communicating with a computing entity 10. For example, the controller 30 may comprise a communication interface 620 for receiving executable instructions, command sets, and/or the like from the computing entity 10 and providing output received from the atomic system 110 (e.g., from an optics collection system 80 comprising one or more photodetectors) and/or the result of a processing the output to the computing entity 10. In various embodiments, the computing entity 10 and the controller 30 may communicate via a direct wired and/or wireless connection and/or one or more wired and/or wireless networks 20.

### Example Method of Performing a Quantum Logic Spectroscopy Operation

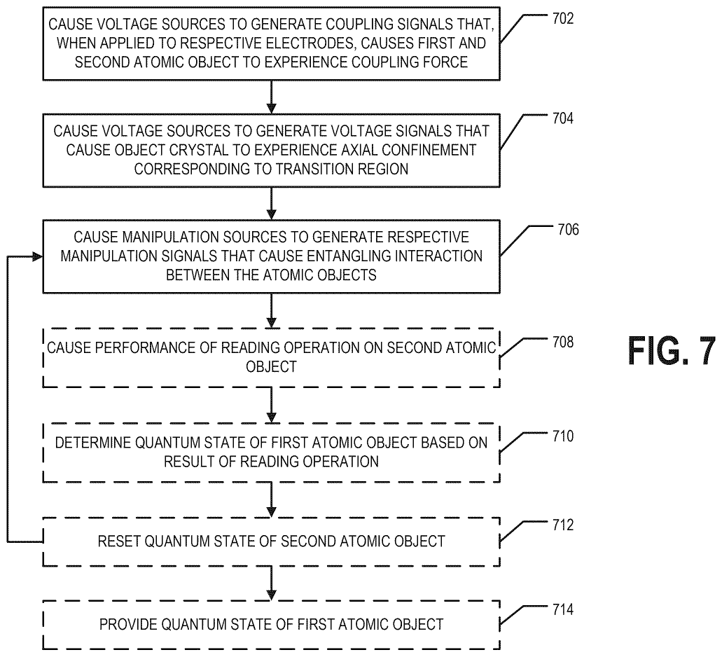

FIG. 7 provides a flowchart illustrating various processes, procedures, and/or the like performed by a controller 30 of an atomic system 110 for performing a quantum logic spectroscopy operation, in accordance with various embodiments. For example, in an example embodiment, quantum logic spectroscopy is performed to determine a quantum state of a first atomic object 312 of an object crystal 310 by performing a reading operation on a second atomic object 314 of the object crystal 310. For example, an object crystal including a first atomic object 312 and a second atomic object 314 may be confined at a target location 305 defined at least in part by a confinement apparatus 200. A quantum logic spectroscopy operation is performed on the object crystal 310 to determine a quantum state of the first atomic object 312 without disturbing the quantum information stored thereby.

Starting at step 702, the controller 30 causes the voltage sources 50 to generate coupling signals that, when applied to respective electrodes (e.g., control electrodes 216) of the confinement apparatus 200, causes the first atomic object 312 and the second atomic object 314 of the object crystal 310 to experience a coupling force 320. For example, the object crystal 310 is confined by a confinement apparatus 200 at a target location 305. The controller 30 causes the generation and provision of coupling signals such that an electric field is generated at the target location 305 that, when the first atomic object 312 and the second atomic object 314 interact with the electric field, the first atomic object 312 and the second atomic object 314 experience respective coupling forces.

In an example embodiment, the coupling force is at the maximum amplitude and the controller 30 causes the coupling force to be maintained as the maximum amplitude. In an example embodiment, an amplitude of the coupling force is increased from a low and/or zero amplitude to a maximum amplitude. For example, the amplitude of the coupling force may be adiabatically increased from a zero amplitude to a maximum amplitude. For example, the controller 30 may control operation of one or more voltage sources 50 to cause the one or more voltage sources 50 to generate and provide coupling signals that increase from zero to a maximum amplitude/voltage. Application of the coupling signals to appropriate control electrodes 216 causes the object crystal 310 to experience a coupling force. For example, providing the coupling signals to one or more control electrodes 216, generates an electric field that when the object crystal interacts therewith, causes the object crystal to experience the coupling force. For example, application of the coupling signal to the one or more control electrodes 216 causes the radial push, shim field, and/or higher order derivative terms of the potential to be generated. The amplitude of the coupling signal (e.g., a voltage signal) increases from zero amplitude to a maximum amplitude/voltage such that the coupling signal has the maximum amplitude/voltage at a second time t₂ of performing a quantum logic spectroscopy operation.

In various embodiments, the amplitude of the coupling signal (and therefore the amplitude of the coupling force) increases slowly with respect to the frequency difference between the mode frequencies of the selected motional modes being coupled to one another. For example, in various embodiments, the time between the first time t₁ and the second time t₂ (e.g., t₂−t₁) is 0.1 to 2 microseconds.

In various embodiments, the controller 30 controls operation of one or more voltage sources 50 via execution of executable instructions by the processing device 605 and/or driver controller elements 615 configured to control operation of the respective voltage sources.

Continuing with FIG. 7, at step 704, the controller 30 causes the voltage sources 50 to generate and provide voltage signals that cause the object crystal 310 located at the target location 305 to experience an axial confinement corresponding to the transition region of the selected motional modes. For example, with reference to FIG. 5, when the selected motional modes are the first motional mode 502A and the second motional mode 502B, the axial confinement experienced by the object crystal 310 is within the transition region 510 such that the mode frequencies of the selected motional modes are near the point of minimum frequency difference 504. For example, the axial confinement experienced by the object crystal 310 is within a specified and/or set range of the minimum difference confinement 506.

In an example embodiment, causing the object crystal 310 to experience an axial confinement corresponding to the transition region 510 includes maintaining the axial confinement such that the object crystal length is maintained (e.g., does not appreciably change). In an example embodiment, causing the object crystal 310 to experience an axial confinement corresponding to the transition region 510 includes increasing the axial confinement such that the object crystal length is caused to decrease. For example, the controller 30 controls operation of one or more voltage sources 50 to cause the voltage sources 50 to generate and provide (e.g., to respective control electrodes 216) voltage signals that cause the axial confinement experienced by the object crystal to increase and the object crystal length to decrease. For example, as illustrated in FIG. 4 at an initial time t₀ of a quantum logic spectroscopy operation, the controller 30 controls operation of one or more voltage sources 50 to cause the voltage sources 50 to generate and provide voltage signals, that when applied to respective control electrodes 216, causes the confinement well within which the object crystal is confined, to reduce in size (at least in the direction defined by the longitudinal axis 205 at the target location 305). The reduction in size of the confinement well causes the atomic objects of the object crystal to be squeezed together such that the object crystal length d is reduced. The reduction in size of the confinement well also causes the confinement well frequency to increase.

In various embodiments, performance of step 702 and step 704 may overlap in time. For example, the voltage signals provided to the control electrodes 216 may include the coupling signals configured to cause the first atomic object 312 and the second atomic object 314 to experience the coupling force and the voltage signals configured to control the axial confinement experienced by the object crystal 310.

As a result of the object crystal 310 experiencing the axial confinement corresponding to the transition region 510 and the coupling force 320, the selected motional modes of the object crystal 310 are coupled to form the mixed motional modes. The mixed motional modes include substantial contributions from both the first atomic object 312 and the second atomic object 314. For example, in various embodiments, the first atomic object 312 and the second atomic object 314 each contribute 5-95% of the energy of a respective mixed motional mode formed by coupling the selected motional modes.

At step 706, the controller 30 controls operation of the manipulation sources 64 to cause one or more manipulation signals to be generated and provided. The one or more manipulation signals are provided such that they are incident on the target location 305, and therefore on the first atomic object 312 and the second atomic object 314 of the object crystal 310 confined at the target location 305. In various embodiments, the one or more manipulation signals are configured to perform an entangling interaction and/or quantum logic gate on the first atomic object 312 and the second atomic object 314. For example, the one or more manipulation signals are configured to perform an entangling interaction and/or quantum logic gate that maps the quantum state of the first atomic object 312 to the second atomic object 314.

In various embodiments, the entangling interaction and/or quantum logic gate performed by the one or more manipulation signals addresses at least one of the mixed motional modes formed by coupling the selected motional modes.

In various embodiments, the controller 30 controls operation of one or more manipulation sources 64 via execution of executable instructions by the processing device 605 and/or driver controller elements 615 configured to control operation of the respective manipulation sources. For example, the controller 30 controls operation of one or more manipulation sources 64 to cause the manipulation source(s) to generate and/or provide one or more manipulation signals to a target location 305 via respective beam path(s) 66.

At step 708, the controller 30 causes performance of a reading operation to be performed on the second atomic object. In an example embodiment, causing performance of a reading operation includes causing one or more manipulation sources 64 to generate and provide reading manipulation signals that are incident on the target location 305. When the second atomic object 314 is in a first quantum state, interaction of the second atomic object 314 with the reading manipulation signal will cause the second atomic object to fluoresce. For example, when the second atomic object 314 is in the first quantum state, interaction with the reading manipulation signal causes the second atomic object to generate, emit, and/or fluoresce photons characterized by a particular wavelength. The optics collection system 80 is configured to capture and/or detect the photons generated, emitted, and/or fluoresced by the second atomic object 314 and provide a sensor signal to the controller 30 indicating the capturing and/or detection of the photons.

When the second atomic object 314 is not in the first quantum state (e.g., the second atomic object 314 is in a second quantum state that is different from the first quantum state), the second atomic object 314 does not fluoresce in response to interacting with the reading manipulation signal. In such an instance, the optics collection system 80 provides a sensor signal to the controller 30 indicating that fluoresced photons were not detected in response to the reading manipulation signal interacting with the second atomic object 314.

In various embodiments, the reading manipulation signal is off resonant with transitions of the first atomic object 312. For example, if the reading manipulation signal is incident on the first atomic object 312, the reading manipulation signal does not destroy or cause loss of the quantum information stored by the first atomic object 312.

In various embodiments, the controller 30 processes the sensor signal that was generated by the optics collection system 80 and received by the controller 30. In various embodiments, the controller 30 determines a quantum state of the second atomic object 314 based on processing the sensor signal. In an example embodiment, the controller 30 determines whether the second atomic object 314 is in the first quantum state or not based on whether or not fluorescence was detected by the optics collection system 80 (as indicated by the amplitude or other characteristic of the sensor signal). For example, when the sensor signal indicates that fluorescence was detected by the optics collection system 80, the controller 30 determines that the second atomic object 314 is in the first quantum state and when the sensor signal indicates that fluorescence was not detected by the optics collection system, the controller 30 determines that the second atomic object 314 is not in the first quantum state.

At step 710, the controller 30 determines the quantum state of the first atomic object based on the result of the reading operation. For example, as a result of the entangling interaction and/or quantum logic gate performed on the first atomic object 312 and the second atomic object 314, the quantum information stored by the first atomic object 312 is mapped to the second atomic object 314. For example, when it is determined that the second atomic object 314 is in the first quantum state, which implies that the first atomic object 312 is in a quantum state that, when mapped to the second atomic object via the entangling operation and/or quantum logic gate, corresponds to the first quantum state. In another example, when it is determined that the second atomic object 314 is not in the first quantum state, that implies that the first atomic object 312 is in a quantum state that, when mapped to the second atomic object via the entangling operation and/or quantum logic gate, does not correspond to the first quantum state. Thus, by knowing the quantum state of the second atomic object 314, the controller 30 infers and/or determines the quantum state of the first atomic object 312.

In various embodiments, steps 706, 708, and 710 may be repeated multiple times such that a distribution of reding operation results are obtained. For example, steps 706, 708, and 710 may be repeated to sample the quantum state of the first atomic object 312 multiple times. For example, by mapping the quantum information stored by the first atomic object 312 to the second atomic object 314 (without affecting the quantum information stored by the first atomic object) and performing the reading operation on the second atomic object multiple times, a distribution of read quantum states of the second atomic object is generated. The distribution of the read quantum states of the second atomic object and/or a distribution of inferred quantum states of the first atomic object may be processed to determine, with a high level of confidence, the quantum state of the first atomic object 312.

In various embodiments where steps 706, 708, and 710 are repeated multiple times, the quantum state of the second atomic object 314 may be reset to an initial state each time between performance of the reading operation and the next performance of the entangling interaction and/or quantum logic gate. For example, at step 712, the controller 30 causes the quantum state of the second atomic object 314 to be reset to an initial state. For example, the controller 30 may cause one or more manipulation sources 64 to generate and provide reset manipulation signals to the target location that causes the quantum state of the second atomic object to be reset to the initial state. In various embodiments, the reset manipulation signal is off resonant for transitions of the first atomic object 312, such that the quantum information stored by the first atomic object is not destroyed or lost as a result of the reset manipulation signal being incident on the first atomic object 312.

At step 714, the controller 30 provides the quantum state of the first atomic object 312. For example, the controller 30 may provide the quantum state of the first atomic object such that the quantum state of the first atomic object 312 is stored in memory 610. In another example, the controller 30 may provide the quantum state of the first atomic object such that the quantum state of the first atomic object 312 is transmitted for receipt by the classical computing entity 10. In various embodiments, the controller 30 may provide the quantum state of the first atomic object such that the quantum state of the first atomic object is displayed via a display (e.g., display 816 of the classical computing entity 10) and/or provided as input to an algorithm and/or program operating/executing on the controller 30 and/or the classical computing entity 10.

### Technical Advantages

Various embodiments provide technical solutions to technical challenges related to performing quantum logic spectroscopy. In various contexts, an atomic object of interest (e.g., an ion that is used as an atomic clock or as a qubit in a trapped ion quantum computer) is confined by a confinement apparatus in association with a spectator atomic object, such as a sympathetic cooling atomic object. For example, the sympathetic cooling atomic object may be used to laser cool the atomic object of interest without disturbing the quantum information stored by the atomic object of interest. The spectator atomic object is a different atomic species than the atomic object of interest. In particular, the spectator atomic object is often an atomic species that has a less complicated energy structure than the ion of interest. For example, the atomic object of interest may have a non-zero and/or non-integer nuclear spin such that the atomic object of interest exhibits hyperfine splitting. The spectator atomic object may have a nuclear spin of zero.

Quantum logic spectroscopy takes advantage of the presence of the spectator atomic object to assist in reading the quantum state of the atomic object of interest. For example, a quantum logic gate is performed that entangles the atomic object of interest and the spectator atomic object without affecting the quantum state of the atomic object of interest. For example, the quantum state of the atomic object of interest may be mapped to the spectator atomic object. The quantum state of the spectator atomic object is then read such that the quantum state of the atomic object of interest may be determined without affecting the quantum state thereof.

As the spectator atomic object and the atomic object of interest are different atomic species, they have different masses. This results in the radial motional modes of an object crystal including the atomic objects to decouple. In particular, some of the radial motional modes of the object crystal are dominated by the spectator atomic object and the other radial motional modes of the object crystal are dominated by the atomic object of interest. As the entangling interaction and/or quantum logic gate performed on the atomic object of interest and the spectator object communicates with the radial motional modes of the object crystal, the decoupling of the radial motional modes of the object crystal causes the performance of the entangling interaction and/or quantum logical gate to be more complicated and/or take a significant amount of time. The longer an entangling interaction and/or quantum logic gate takes to perform, the larger the effect of noise on the entangling interaction and/or quantum logic gate. In other words, when an entangling interaction and/or quantum logic gate takes a long time to perform, the fidelity of the entangling interaction and/or quantum logic gate may be negatively affected. Therefore, technical problems exist regarding performance of quantum logic spectroscopy.

Various embodiments provide technical solution to these technical challenges. In various embodiments, selected motional modes of the object crystal are coupled to form mixed motional modes that include substantial contributions from both the first atomic object and the second atomic object. An entangling interaction and/or quantum logic gate may be performed on the atomic objects that addresses the mixed motional modes to map quantum information stored by an atomic object of interest to a spectator quantum object. This enables the entangling interaction and/or quantum logic gate to be performed more quickly (e.g., on a similar time scale as performing an entangling interaction and/or quantum logic gate on two atomic objects of the same atomic species). The shortened time frame of the entangling interaction and/or quantum logic gate (compared to when the motional modes are not coupled) allows the entangling interaction and/or quantum logic gate to be performed with high fidelity. Moreover, the technical complexity of performing the entangling interaction and/or the quantum logic gate on the two atomic objects of different atomic species is not substantially increased from performing an entangling interaction and/or the quantum logic gate on two atomic objects of the same atomic species. Therefore, various embodiments, provide technical improvements to the fields of atomic systems and quantum logic spectroscopy.

### Example Computing Entity

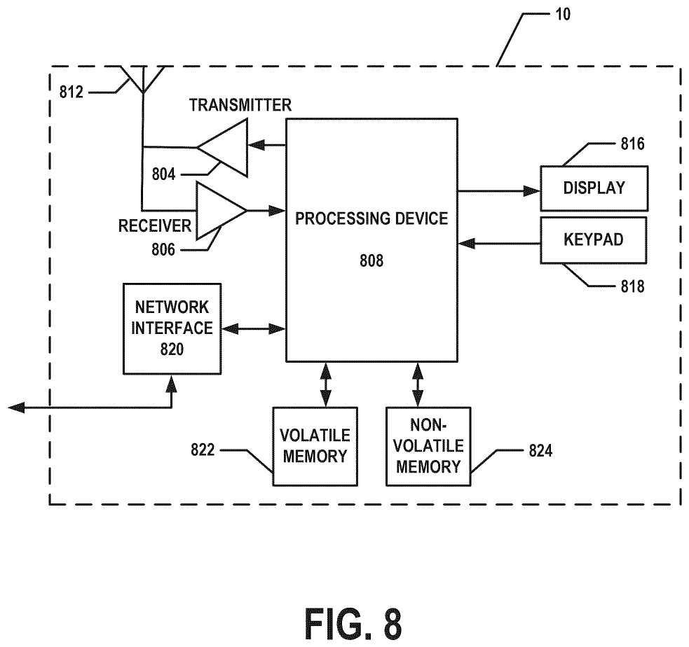

FIG. 8 provides an illustrative schematic representative of an example computing entity 10 that can be used in conjunction with embodiments of the present invention. In various embodiments, a computing entity 10 is configured to allow a user to provide input to the atomic system 110 (e.g., via a user interface of the computing entity 10) and receive, display, analyze, and/or the like output from the atomic system 110.

As shown in FIG. 8, a computing entity 10 can include an antenna 812, a transmitter 804 (e.g., radio), a receiver 806 (e.g., radio), and a processing device 808 that provides signals to and receives signals from the transmitter 804 and receiver 806, respectively. The signals provided to and received from the transmitter 804 and the receiver 806, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 comprises a network interface 820 configured to communicate via one or more wired and/or wireless networks 20.

In various embodiments, the processing device 808 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products.

The computing entity 10 may also comprise a user interface device comprising one or more user input/output interfaces (e.g., a display 816 and/or speaker/speaker driver coupled to a processing device 808 and a touch screen, keyboard, mouse, and/or microphone coupled to a processing device 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
causing one or more voltage sources to generate coupling signals that cause a first atomic object and a second atomic object of an object crystal to experience a coupling force, wherein the object crystal is confined at a target location of a confinement apparatus, the confinement apparatus defines an axis at the target location, and the coupling force comprises a component in a direction that is radial to the axis;
causing the one or more voltage sources to generate voltage signals that cause the object crystal to experience an axial confinement corresponding to a transition region for selected motional modes of the object crystal, wherein when the first atomic object and the second atomic object experience the coupling force and the object crystal experiences the axial confinement corresponding to the transition region, the selected motional modes form mixed motional modes; and
causing one or more manipulation sources to generate respective manipulation signals such that the respective manipulation signals are incident on the target location, wherein the respective manipulation signals address at least one of the mixed motional modes to cause an entangling interaction between the first atomic object and the second atomic object.

2. The method of claim 1, wherein the first atomic object has a first mass, the second atomic object has a second mass, and the first mass is not equal to the second mass.

3. The method of claim 1, wherein the first atomic object and the second atomic object are ions of different atomic species that are confined by a Paul ion trap.

4. The method of claim 1, wherein the first atomic object that is an atomic object of interest and the second atomic object that is a spectator atomic object.

5. The method of claim 4, wherein the spectator atomic object is used to sympathetically cool the atomic object of interest.

6. The method of claim 4, further comprising:
causing performance of a reading operation on the spectator atomic object; and
based on a result of the reading operation, determining a quantum state of the atomic object of interest.

7. The method of claim 1, wherein the coupling force is caused by interaction of the first atomic object and the second atomic object with an electric field.

8. The method of claim 1, wherein causing the one or more voltage sources to generate voltage signals to cause the object crystal to experience the axial confinement corresponding to the transition region comprises causing the one or more voltage sources to generate voltage signals that cause the axial confinement to increase from an initial confinement value to a final confinement value corresponding to the transition region such that the axial confinement increases adiabatically.

9. The method of claim 8, wherein the axial confinement experienced by the object crystal increases from the initial confinement value to the final confinement value over a time period that is longer than an inverse of a frequency difference between the selected motional modes.

10. The method of claim 9, wherein an amplitude of the coupling force increases from zero to an interaction amplitude adiabatically over the time period that is longer than the inverse of the frequency difference between the selected motional modes.

11. The method of claim 1, wherein both the first atomic object and the second atomic object make substantial contributions to the mixed motional modes.

12. The method of claim 1, wherein, prior to the respective manipulation signals being incident on the target location, an amplitude of the coupling force increases from zero to an interaction amplitude adiabatically.

13. A system comprising:
a confinement apparatus configured to confine an object crystal comprising a first atomic object and a second atomic object at a target location defined at least in part by the confinement apparatus;
one or more manipulation sources configured to generate and provide respective manipulation signals;
one or more voltage sources configured to provide respective voltage signals to respective electrodes of the confinement apparatus; and
a controller configured to control operation of the one or more manipulation sources and the one or more voltage sources, wherein the controller is configured to:
cause the one or more voltage sources to generate coupling signals that cause the first atomic object and the second atomic object of the object crystal to experience a coupling force, wherein the confinement apparatus defines an axis at the target location and the coupling force comprises a component in a direction that is radial to the axis;
cause the one or more voltage sources to generate voltage signals that cause the object crystal to experience an axial confinement corresponding to a transition region for selected motional modes of the object crystal, wherein while the first atomic object and the second atomic object experience the coupling force and the object crystal experiences the axial confinement corresponding to the transition region, the selected motional modes form mixed motional modes; and
cause the one or more manipulation sources to generate respective manipulation signals such that the respective manipulation signals are incident on the target location, wherein the respective manipulation signals address at least one of the mixed motional modes to cause an entangling interaction between the first atomic object and the second atomic object.

14. The system of claim 13, wherein the first atomic object has a first mass, the second atomic object has a second mass, and the first mass is not equal to the second mass.

15. The system of claim 13, wherein the first atomic object and the second atomic object are ions of different atomic species, and the confinement apparatus is a Paul ion trap.

16. The system of claim 13, wherein the first atomic object that is an atomic object of interest and the second atomic object that is a spectator atomic object.

17. The system of claim 16, wherein the controller is further configured to:
cause performance of a reading operation on the spectator atomic object; and
based on a result of the reading operation, determine a quantum state of the atomic object of interest.

18. The system of claim 13, wherein the coupling force is caused by interaction of the first atomic object and the second atomic object with an electric field.

19. The system of claim 13, wherein causing the one or more voltage sources to generate voltage signals to cause the object crystal to experience the axial confinement corresponding to the transition region comprises causing the one or more voltage sources to generate voltage signals that cause the axial confinement to increase from an initial confinement value to a final confinement value corresponding to the transition region such that the axial confinement increases adiabatically.

20. The system of claim 13, wherein both the first atomic object and the second atomic object make substantial contributions to the mixed motional modes.
